(19) United States
(12) Patent Application Publication
(10) Pub. No.: US 2011/0264458 A1
(43) Pub. Date: Oct. 27, 2011

(54) SYSTEM AND METHOD FOR ASSIGNING A SEAT BASED ON USAGE SITUATIONS OF PRINTING APPARATUS

(75) Inventor: Takashi Saitoh, Tokyo-to (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/095,047

(22) Filed: Apr. 27, 2011

Related U.S. Application Data
(60) Provisional application No. 61/328,397, filed on Apr. 27, 2010.

(51) Int. Cl. G06Q 10/00; G06F 3/12; H04N 1/60

(52) U.S. Cl. 705/1.1; 358/1.9; 358/1.15

(57) ABSTRACT

According to one embodiment, a system includes a memory configured to store seat information which applies rank order to a plurality of seats for each of printing apparatuses, an interface configured to acquire log information on print jobs from the printing apparatuses and store the acquired log information in the memory, and a controller configured to aggregate the number of sheets printed by each of the printing apparatuses for each of users on the basis of the log information, specify the printing apparatus for each of the users using the number of sheets printed by each of the printing apparatuses aggregated for each of the users and determine a seat assignment order for the users, and assign a seat which is not yet assigned and has the highest rank from among the seats rank ordered for the printing apparatus specified for the users in the determined order.

### CROSS-REFERENCE TO RELATED APPLICATIONS

This application is based upon and claims the benefit of U.S. Provisional Application No. 61/328,397, filed on Apr. 27, 2010; the entire contents of which are incorporated herein by reference.

### FIELD Embodiments described herein relate generally to a system and method for assigning a seat based on usage situations of printing apparatus.

### BACKGROUND

In offices or the like, a plurality of printing apparatuses is used, and image forming apparatuses (MFP: Multi-Function Peripheral) are also used as printing apparatuses. An MFP is a digital multi-function peripheral that not only scans, reads, and copies images with a designated resolution and a sheet size, but also synthetically applies functions of various office machines such as an image receiving function using FAX, an image receiving function using e-mail, and a print image receiving function using a network.

Hitherto, the arrangement of seats of users and printing apparatuses has not been managed with any particular connection. Therefore, if the seats of users are assigned using a system according to the related art when the users come to work, there were cases where a reduction in efficiency of printing operations resulted. For example, if users who frequently use a printing apparatus are positioned in the proximity of the particular printing apparatus, the rate of operation of the particular printing apparatus is increased, so that the waiting time is increased. Conversely, if users who rarely use the printing apparatus are positioned in the proximity of the printing apparatus, convenience is degraded for users who frequently use the printing apparatus.

Therefore, there is a need for a seat assignment technique to enhance the efficiency of the printing operations on the basis of usage situations of the printing apparatus for each user.

### BRIEF DESCRIPTION OF THE DRAWINGS

FIG. 1 is an exemplary diagram showing a simplified configuration of a printing system including a seat assignment system according to an embodiment.

FIG. 2 is an exemplary diagram showing a configuration of the seat assignment system according to the embodiment.

FIG. 3 is an exemplary diagram showing a floor arrangement of printing apparatuses and PCs, which is processed by the seat assignment system according to the embodiment.

FIG. 4 is an exemplary diagram showing a priority rank order of seat positions and an assignment order of seats according to the embodiment.

FIG. 5 is an exemplary flowchart showing a seat assignment process according to the embodiment.

FIG. 6 is an exemplary diagram showing a usage situation of each user according to the embodiment.

FIG. 7 is an exemplary flowchart showing an MFP priority rank order determination process according to the embodiment.

FIG. 8 is an exemplary flowchart showing a printer priority rank order determination process according to the embodiment.

FIG. 9 is an exemplary diagram for explaining input and output information on a seat assignment order determination process according to the embodiment.

FIG. 10 is an exemplary flowchart showing a seat determination process according to the embodiment.

FIG. 11 is an exemplary diagram showing an input and output screen of a seat acquisition panel according to the embodiment.

FIG. 12 is an exemplary flowchart showing a seat assignment process according to a second embodiment.

FIG. 13 is an exemplary diagram showing counter data for each user according to the second embodiment.

### DETAILED DESCRIPTION

In general, according to one embodiment, a system for assigning a plurality of seats to a plurality of users who use a plurality of printing apparatuses, includes a memory configured to store seat information which applies rank order to the plurality of seats for each of the printing apparatuses an interface configured to acquire log information on print jobs from the printing apparatuses and store the acquired log information in the memory, and a controller configured to aggregate the number of sheets printed by each of the printing apparatuses for each of the users on the basis of the log information, specify the printing apparatus for each of the users using the number of sheets printed by each of the printing apparatuses aggregated for each of the users and determine a seat assignment order for the users, and assign a seat which is not yet assigned and has the highest rank from among the seats rank ordered for the printing apparatus specified for the users in the determined order.

### First Embodiment

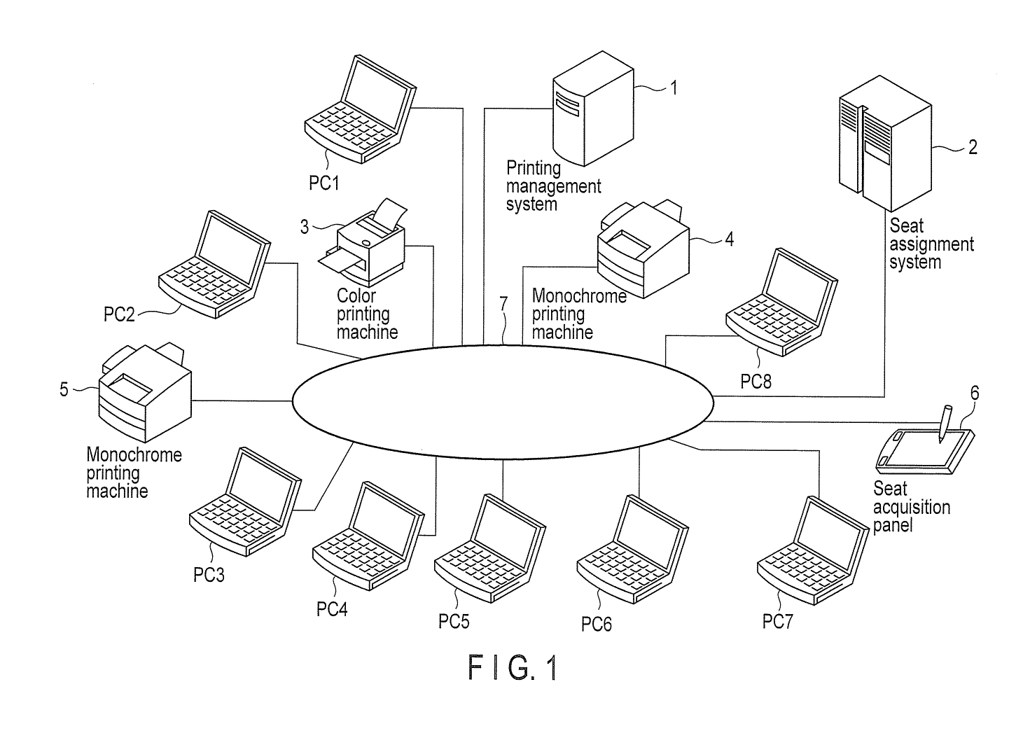

FIG. 1 is an exemplary diagram showing a simplified configuration of a printing system including a seat assignment system according to an embodiment.

The printing system shown in FIG. 1 includes a printing management system 1, a seat assignment system (server) 2, a color printing apparatus 3, monochrome printing apparatuses 4 and 5, a seat acquisition panel 6, personal computers PC1 to PC8, and a network 7.

The printing management system 1 manages the use of the color printing apparatus 3 and the monochrome printing apparatuses 4 and 5. The seat assignment system 2 assigns seats to users on the basis of log history information regarding printing acquired from the color printing apparatus 3 and the monochrome printing apparatuses 4 and 5.

The monochrome printing apparatuses 4 and 5 are typical printing apparatuses and perform printing using a single color. The color printing apparatus 3 is an MFP and is able to do color printing. The color printing apparatus 3 is able to do mass printing and high-speed printing compared to the monochrome printing apparatuses 4 and 5.

The seat acquisition panel 6 is an input and output terminal device for inputting setting information to the seat assignment system 2 and displaying output information from the seat assignment system 2. Users acquire seat information assigned to the users using the seat acquisition panel 6. Detailed description will be provided later.

PC1 to PC8 are provided for the respective seats. The user performs printing operations or the like using the PCs provided for the designated seats. All the apparatuses described above are connected to the network 7.

Next, a printing process will be described.

The user performs user authentication on the PCs to log in and may use the printing system. The user designates jobs for which printing is desired, and inputs the jobs to the printing management system 1. The printing management system 1 acquires information regarding the users (user ID and the like) as well as information regarding the jobs (job ID, job name, and the like) and manages information regarding jobs for each user.

The user selects the printing apparatuses 3 to 5 that print the corresponding jobs and moves to the front of the printing apparatuses 3 to 5. The user performs user authentication from the control panels of the printing apparatuses 3 to 5, selects jobs for which printing is desired, and sets and inputs print instructions. Through this operation, the jobs are sent to the printing apparatuses 3 to 5 from the printing management system 1 and thus printing of the jobs is performed. The printing apparatuses 3 to 5 store information regarding the printing of the corresponding jobs (printing attributes and the like).

The seat assignment system 2 collects log information regarding the printing from the printing apparatuses 3 to 5 at regular predetermined timings. The collected log information includes user ID, printing time, job name, printing apparatus ID, printing attributes, and the like. The printing attributes include the number of sheets printed, print pages, print copies, distinguishing between color printing and monochrome printing, and distinguishing between single-sided printing and double-sided printing. As the predetermined timing at which the log information is collected, an arbitrary time period of from several seconds to several hours may be employed.

In addition, according to another embodiment, when the printing apparatuses 3 to 5 finish the printing, the log information regarding the printing may be transmitted to the seat assignment system 2. Moreover, the seat assignment system 2 may acquire the log information regarding the printing by communicating with the printing management system 1 as well as communicating with the printing apparatuses 3 to 5.

The seat assignment system 2 appropriately retrieves, extracts, and aggregates the log information collected as described above and stored as history data, for a seat assignment process. That is, the seat assignment system 2 retrieves, extracts, and aggregates usage situations of the printing apparatuses 3 to 5 for each user at particular periods. In addition, the process of assigning a seat for each user is performed on the basis of the aggregation result. In addition, the log information at the particular periods may be print log information on the day or the previous day, print log information at a particular period in the past (a week, a month, a year, and the like), print log information in AM, print log information in PM, and the like.

Next, operations of the seat assignment system 2 according to this embodiment will be described.

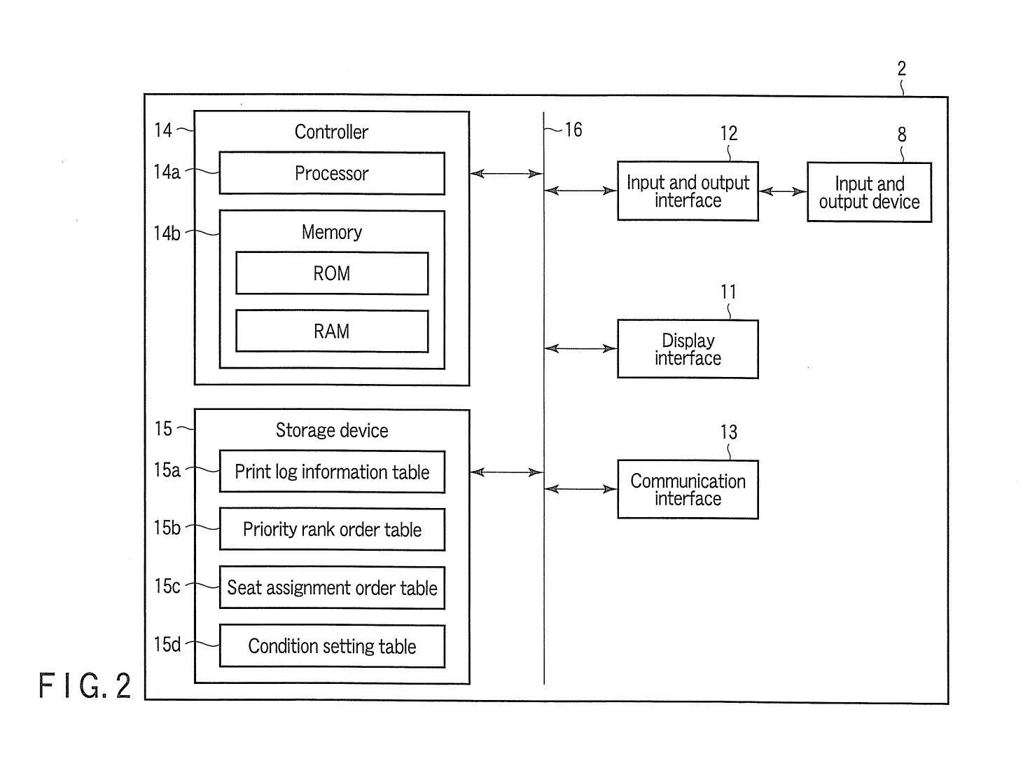

FIG. 2 is an exemplary diagram showing a configuration of the seat assignment system 2 according to this embodiment. The seat assignment system 2 includes software, hardware, or a suitable combination thereof for executing communications and the like with the apparatuses on the network 7.

The seat assignment system 2 includes an input and output device 8, a display interface 11, an input and output interface 12, a communication interface 13, a controller 14, a storage device 15, and a BUS 16.

The controller 14 includes a processor 14a comprising a CPU (Central Processing Unit) or an MPU (Micro Processing Unit) and a memory 14b.

The storage device 15 stores a print log information table 15a, a priority rank order table 15b, a seat assignment order table 15c, and a condition setting table 15d. As the storage device 15, a magnetic storage device such as a hard disk drive, an optical storage device, a semiconductor storage device such as a flash memory, or an arbitrary combination thereof may be employed. In addition, the seat assignment system 2 may use, instead of the storage device 15, a server, a PC, or other storage devices connected via the communication interface 13.

The display interface 11 is an interface for transceiving information with the seat acquisition panel 6. The input and output interface 12 is an interface for transceiving information with the input and output device 8. The communication interface 13 is an interface for transceiving information with the network 7.

In addition, the information regarding seat acquisition may be input from the seat acquisition panel 6 when the user comes to work. A particular period or the like at which the above-described log information is aggregated may be input from the input and output device 8.

The controller 14 controls the overall operations of the seat assignment system 2. The processor 14a executes various programs for operating the seat assignment system 2. The memory 14b is provided with a ROM (Read Only Memory) and a RAM (Random Access Memory). The ROM is a read-only memory. In the ROM, basic software such as an operating system (OS), applications, and data are stored. The RAM is used as a work area during the processes of the controller 14.

The storage device 15 stores various data tables used for the operations of the controller 14.

The print log information table 15a stores print log history data. The priority rank order table 15b prescribes a priority rank order of seats determined for the printing apparatuses 3 to 5. Details will be described later. The seat assignment order table 15c prescribes an assignment order of seats determined for the printing apparatuses 3 to 5. Details will be described later. The condition setting table 15d prescribes various threshold values and constants used for the operations of the controller 14.

The BUS 16 is connected to the display interface 11, the input and output interface 12, the communication interface 13, the controller 14, and the storage device 15 and configures information communication paths between the devices.

In addition, the seat assignment system 2 may include the seat acquisition panel 6. In addition, the seat assignment system 2 need not necessarily include the input and output device 8 and the input and output device 8 may be configured as an external device.

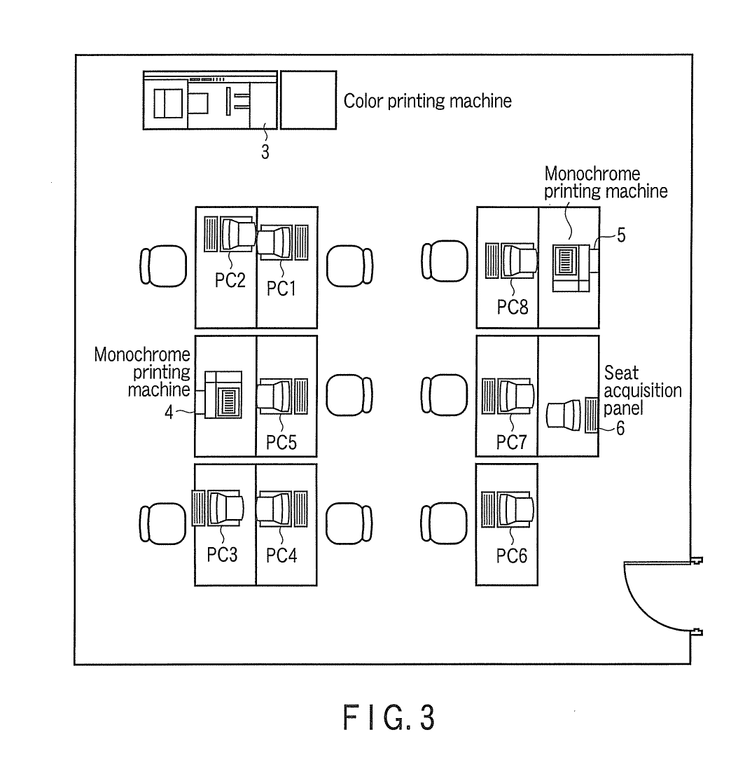

FIG. 3 is an exemplary diagram showing a floor arrangement of the printing apparatuses and the PCs, which is processed by the seat assignment system 2 according to this embodiment.

In preparation, a manager of the seat assignment system 2 determines the priority rank order and the seat assignment order of the seat positions. With regard to the priority rank order of the seat positions, the seat positions are assigned in order of shortest distance from the printing apparatuses 3 to 5 with reference to the layout of the office shown in FIG. 3.

In addition, in the following description, for the sake of simplification, the seat positions are shown as the PC1 to PC8. In addition, the color printing apparatus 3 is shown as an MFP. In addition, the monochrome printing apparatuses 4 and 5 are shown as printers.

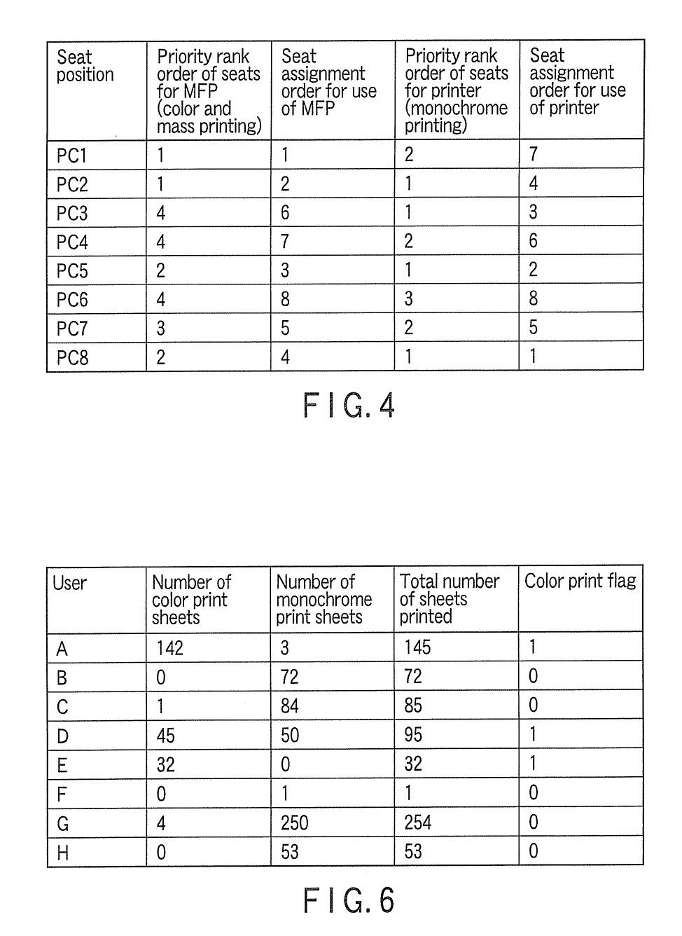

FIG. 4 is an exemplary diagram showing the priority rank order of the seat positions and the assignment order of the seats according to this embodiment.

The manager sets the priority rank order from the arrangement of the seats, the MFP, and the printers through the input and output device 8 with reference to FIG. 3. The manager first sets the priority rank order of the seats for the MFP. As described above, the priority rank order is set based on the shortest distance from the MFP. Here, it is preferable that whether it is close or distant be determined not based on a straight line, but on the distance by which the user moves from their seat to the front of the MFP.

For example, in the case of the MFP, the PC1 and the PC2 positioned in closest proximity are set to first in the priority rank order. The PC5 and the PC8 on the next desks from the position are set to second in the priority rank order. The PC7 on the next desk therefrom is set to third in the priority rank order, and the other seats are set to fourth in the priority rank order.

Subsequently, the manager sets the priority rank order of the seats for the printers with reference to FIG. 3. In the case of the printers, similarly, next or front seats rank first in the priority rank order, the next seats thereto rank second in the priority rank order, and the other seats rank third in the priority rank order. In addition, the priority rank order is not limited to the fourth priority rank in this embodiment and there may be an arbitrary number of priority ranks.

From the priority rank order set by the manager, the seat assignment order for use of the MFP and the printers is determined. Unique numbers are assigned to the ranks of the priority rank order in ascending order. In the example shown in FIG. 4, for the MFP and the printers, unique numbers are assigned in the seat order to from the first priority rank in ascending order. In the case of the same priority rank, the MFP sets the seat order so that the seat order is assigned in ascending order of the PC number, and the printers set the seat order so that the seat order is assigned in descending order of the PC number. In addition, this seat assignment order is automatically assigned by the seat assignment system 2.

The priority rank order set by the manager is stored in the priority rank order table 15b, and the seat assignment order automatically assigned by the seat assignment system 2 is stored in the seat assignment order table 15c.

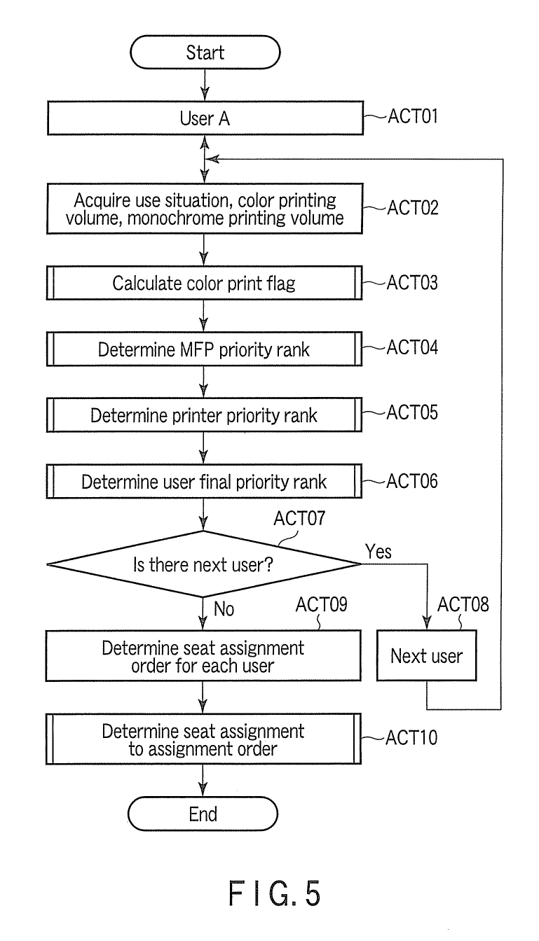

FIG. 5 is an exemplary flowchart showing a seat assignment process according to this embodiment. In this embodiment, at a predetermined time after starting work on the day, the seat assignment system 2 performs the seat assignment process in advance for the next day.

In ACT 01, the seat assignment system 2 selects a user A as a process object. In addition, in this embodiment, 8 users A to H are objects. In ACT 02, for the selected user A, the print log information table 15a is retrieved to acquire the usage situation of the printing apparatus on the previous day.

FIG. 6 is an exemplary diagram showing the usage situation of each user according to this embodiment. The seat assignment system 2 acquires the number of color print sheets, the number of monochrome print sheets, and the total number of sheets printed for the user A. The total number of sheets printed is the sum of the number of color print sheets and the number of monochrome print sheets.

In ACT 03, the seat assignment system 2 calculates a color print flag from information regarding the acquired usage situation. The color print flag is a flag indicating whether or not color printing is performed on 5 or more sheets. When the number of color print sheets is 5 or more, the color print flag is set to 1, and in other cases, the color print flag is set to 0. Since the number of color print sheets of the user A is 142, the color print flag is set to 1. In addition, a threshold value (for example, 5 sheets described above) for setting the color print flag is stored in the condition setting table 15d to correspond to the period of the acquired print log information.

In ACT 04, the seat assignment system 2 determines the priority rank order for the MFP. As described above, the MFP is able to do high-speed printing and can output in color. Therefore, when the total number of sheets printed is large or color printing is performed in use on the previous day, it is determined that a seat close to the MFP is to be selected with priority.

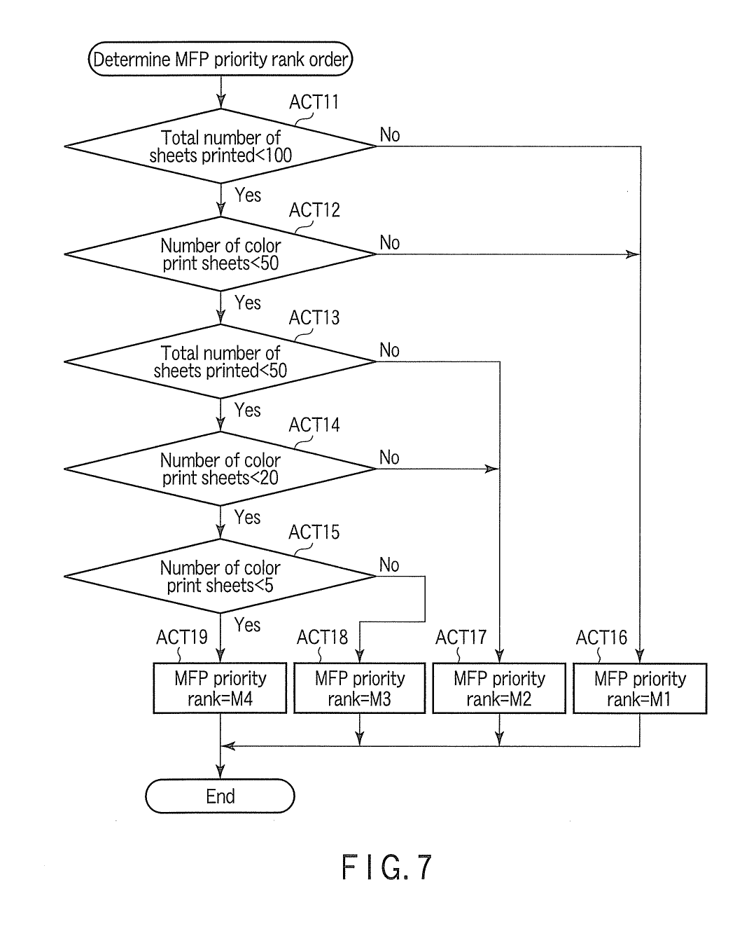

FIG. 7 is an exemplary flowchart showing an MFP priority rank order determination process according to this embodiment.

In ACT 11 and ACT 12 of FIG. 7, when the total number of sheets printed is equal to or more than 100 or the number of color print sheets is equal to or more than 50, in ACT 16, the MFP priority rank is set to M1 representing the highest priority rank. In ACT 13 and ACT 14, when the total number of sheets printed is less than 100 and equal to or more than 50, or when the number of color print sheets is less than 50 and equal to or more than 20, in ACT 17, the MFP priority rank is set to M2 representing the second highest priority rank. In ACT 15, when the number of color print sheets is less than 20 and equal to or more than 5, in ACT 18, the MFP priority rank is set to M3. In ACT 15, when the number of color print sheets is less than 5, in ACT 19, the MFP priority rank is set to M4.

As shown in FIG. 6, the total number of sheets printed of the user A is 145, and the number of color print sheets is 142. Therefore, according to the workflow of the MFP priority rank order determination process of FIG. 7, the MFP priority rank of the user A is set to M1.

In ACT 05 of FIG. 5, the seat assignment system 2 determines the priority rank order for the printers. As described above, when compared to the MFP, the printers need more time to output printed matter, and cannot perform color printing. Therefore, when the number of color print sheets is 0 and the number of monochrome print sheets is large in use on the previous day, it is determined that a seat close to the printers is to be selected with priority.

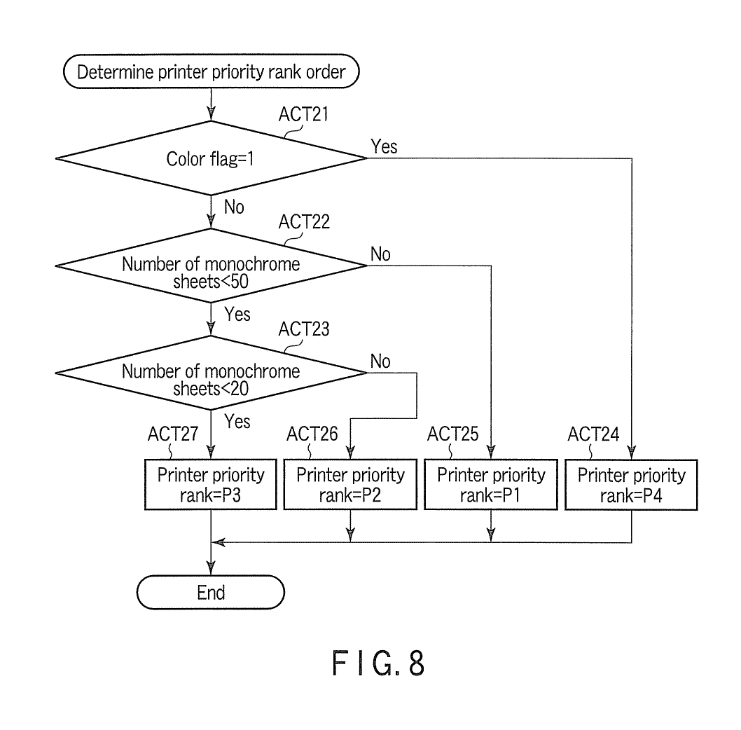

FIG. 8 is an exemplary flowchart showing a printer priority rank order determination process according to this embodiment.

In ACT 21, when the color flag is 1, that is, when color printing is performed in use on the previous day, in ACT 24, the printer priority rank is set to P4 which is the lowest priority rank. In ACT 22, when the color flag is 0 and the number of monochrome print sheets is equal to or more than 50, in ACT 25, the printer priority rank is set to P1 representing the highest priority rank. In ACT 23, when the color flag is 0 and the number of monochrome print sheets is less than 50 and equal to or more than 20, in ACT 26, the printer priority rank is set to P2 representing the second highest priority rank. In ACT 23, when the color flag is 0 and the number of monochrome print sheets is less than 20, in ACT 27, the printer priority rank is set to P3.

As shown in FIG. 6, the number of color print sheets of the user A is 142, and the number of monochrome print sheets is 3. Therefore, according to the workflow of the printer priority rank order determination process of FIG. 8, the printer priority rank of the user A is set to P4.

In addition, the threshold value of the number of sheets for setting the MFP priority rank order and the printer priority rank order is stored in the condition setting table 15d in response to the period of the acquired print log information.

In ACT 06 of FIG. 5, the seat assignment system 2 sets the final priority rank for the users. In ACT 04 and ACT 05 described above, the MFP priority rank and the printer priority rank of the users are determined. Therefore, one of the two is selected as the final priority rank. In the decision rule, the priority rank having a smaller number is selected as the final priority rank. In the case of the same number, the priority rank of the MFP which has multiple functions is selected as the final priority rank.

The MFP priority rank order, the printer priority rank order, and the final priority rank order set as described above are stored in the priority rank order table.

In ACT 07, whether or not setting of the priority ranks of all the users is performed is examined, and when users for which the priority rank has to be set remain (Yes in ACT 07), in ACT 08, users who become process objects are selected, and the process from ACT 02 is performed.

When setting of the priority ranks of all the users is performed (No in ACT 07), in ACT 09, the seat assignment order for the users is determined.

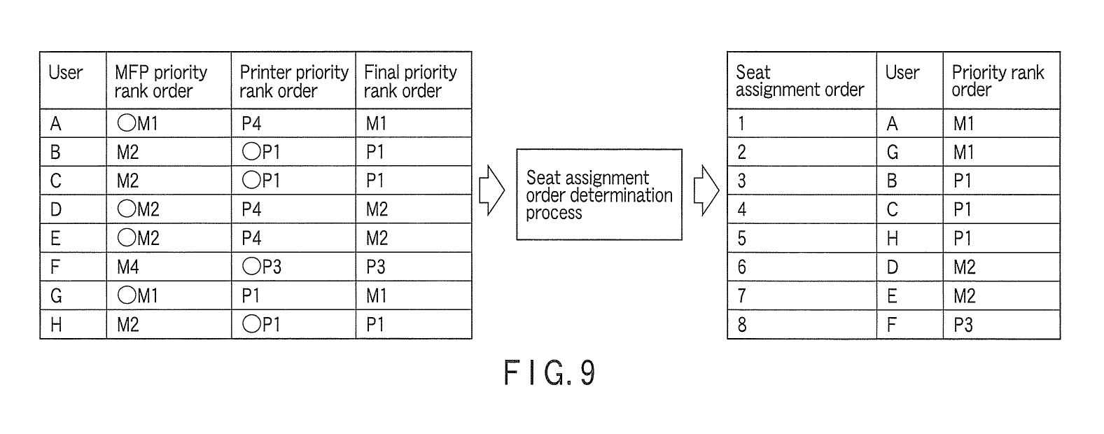

FIG. 9 is an exemplary diagram for explaining input and output information on a seat assignment order determination process according to this embodiment.

On the left of FIG. 9, the MFP priority rank, the printer priority rank, and the final priority rank for each user are shown. In addition, the rank with a circle means that the rank is selected as the final priority rank.

In the seat assignment order determination process, ranks are given on the basis of the final priority ranks in ascending order while the MFP has priority over the printer. On the right of FIG. 9, the orders for assigning seats obtained as the process result are shown. That is, the order in which seats are assigned to the users A to H is shown.

In ACT 10 of FIG. 5, the seat assignment system 2 determines the seats of the users A to H in the assignment order determined by the seat assignment order determination process described above.

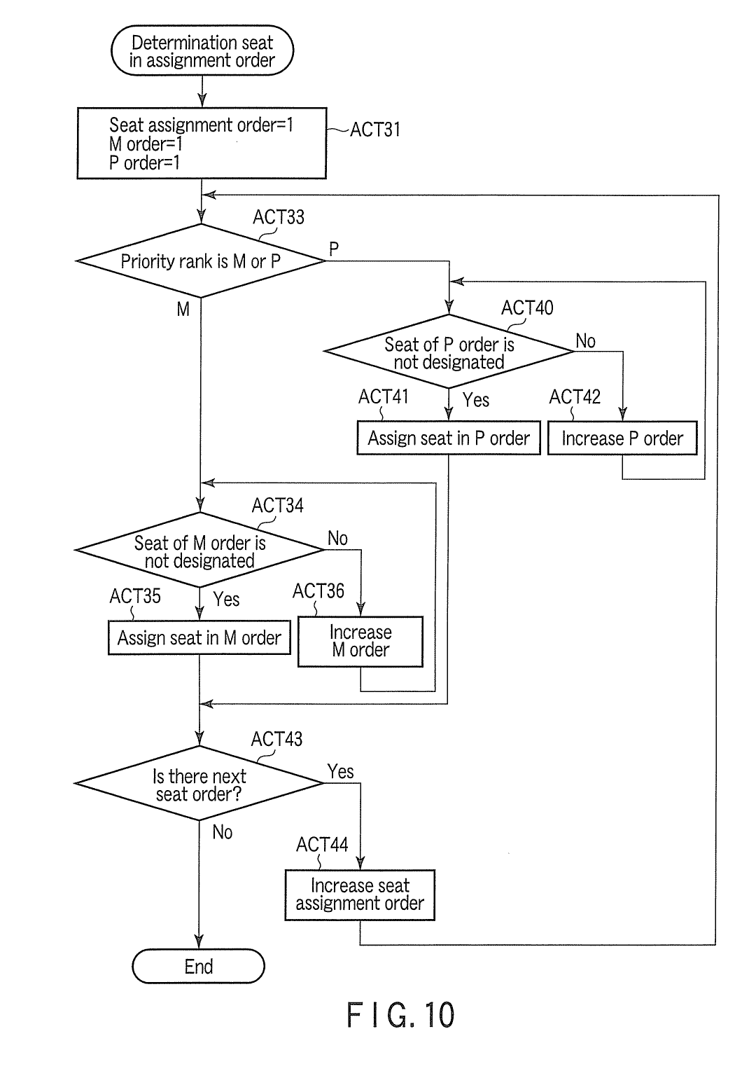

FIG. 10 is an exemplary flowchart showing a seat determination process according to this embodiment. The seat assignment system 2 determines the seats of the users A to H on the basis of the seat assignment order for use of the MFP and the seat assignment order for use of the printer shown in FIG. 4, and the seat assignment order for the users shown on the right of FIG. 9.

In ACT 31, the seat assignment order is set to 1. Accordingly, the seat determination process for the user A for which the seat assignment order is determined as 1 is performed. In addition, a parameter M order is set to an initial value of 1, and a parameter P order is set to an initial value of 1.

### Seat Determination Process For User A

In ACT 33, whether the priority rank of the user A is the MFP (M) or the printer (P) is examined. Since the priority rank of the user A is M1, in ACT 34, whether or not the seat (PC1) for which the seat assignment order for use of the MFP in FIG. 4 is 1 is already designated is examined. Since the seat (PC1) is not yet designated (Yes in ACT 34), in ACT 35, the seat (PC1) for which the seat assignment order for use of the MFP in FIG. 4 is 1 is assigned to the user A.

In ACT 43, whether or not there is still a seat order to be assigned is examined. Since there is still a seat order to be assigned (Yes in ACT 43), in ACT 44, the seat assignment order is increased to 2. Accordingly, the seat determination process for the user G for which the seat assignment order is determined as 2 is performed. Here, the parameter M order is 1, and the parameter P order is 1. In addition, the process from ACT 33 is performed.

### Seat Determination Process For User G

In ACT 33, whether the priority rank of the user G is the MFP (M) or the printer (P) is examined. Since the priority rank of the user G is M1, in ACT 34, whether or not the seat (PC1) for which the seat assignment order for use of the MFP in FIG. 4 is 1 is already designated is examined. Since the seat (PC1) is already designated (No in ACT 34), in ACT 36, the parameter M order is increased to 2.

In ACT 34, whether or not the seat (PC2) for which the seat assignment order for use of the MFP in FIG. 4 is 2 is already designated is examined. Since the seat (PC2) is not yet designated (Yes in ACT 34), in ACT 35, the seat (PC2) for which the seat assignment order for use of the MFP in FIG. 4 is 2 is assigned to the user G.

In ACT 43, whether or not there is still a seat order to be assigned is examined. Since there is still a seat order to be assigned (Yes in ACT 43), in ACT 44, the seat assignment order is increased to 3. Accordingly, the seat determination process for the user B for which the seat assignment order is determined as 3 is performed. Here, the parameter M order is 2, and the parameter P order is 1. In addition, the process from ACT 33 is performed.

### Seat Determination Process For User B

In ACT 33, whether the priority rank of the user B is the MFP (M) or the printer (P) is examined. Since the priority rank of the user B is P1, in ACT 40, whether or not the seat (PC8) for which the seat assignment order for use of the printer in FIG. 4 is 1 is already designated is examined. Since the seat (PC8) is not yet designated (Yes in ACT 40), in ACT 41, the seat (PC8) for which the seat assignment order for use of the printer in FIG. 4 is 1 is assigned to the user B.

In ACT 43, whether or not there is still a seat order to be assigned is examined. Since there is still a seat order to be assigned (Yes in ACT 43), in ACT 44, the seat assignment order is increased to 4. Accordingly, the seat determination process for the user C for which the seat assignment order is determined as 4 is performed. Here, the parameter M order is 2, and the parameter P order is 1. In addition, the process from ACT 33 is performed.

In this manner, hereinafter, according to the seat assignment orders, the seats are assigned to the users in the order of C, H, D, E, and F. The seat assignment result for each of the users is as follows.

For the user C: Since the seat assignment order for use of the printer is second, the PC5 is assigned.

For the user H: Since the seat assignment order for use of the printer is third, the PC3 is assigned.

For the user D: Since the seat assignment order for use of the MFP is third, the PC5 should be assigned. However, since the seat PC5 is already assigned, the next seat PC8 (fourth) should be assigned. However, the seat PC8 is also assigned. Therefore, the next seat PC7 (fifth) is assigned.

For the user E: Since the seat assignment order for use of the MFP is sixth, the PC3 should be assigned. However, since the seat PC3 is already assigned, the next seat PC4 (seventh) is assigned.

For the user F: The seat assignment order for use of the printer is fourth. However, since the fourth to seventh ranks are already assigned, the PC6 (eighth) is assigned.

As described above, the seats are determined in the assignment orders in the M groups and the P groups for each of the users. Here, the seats that are already assigned to other groups are skipped, and the seat which is not yet assigned and has the high rank is assigned.

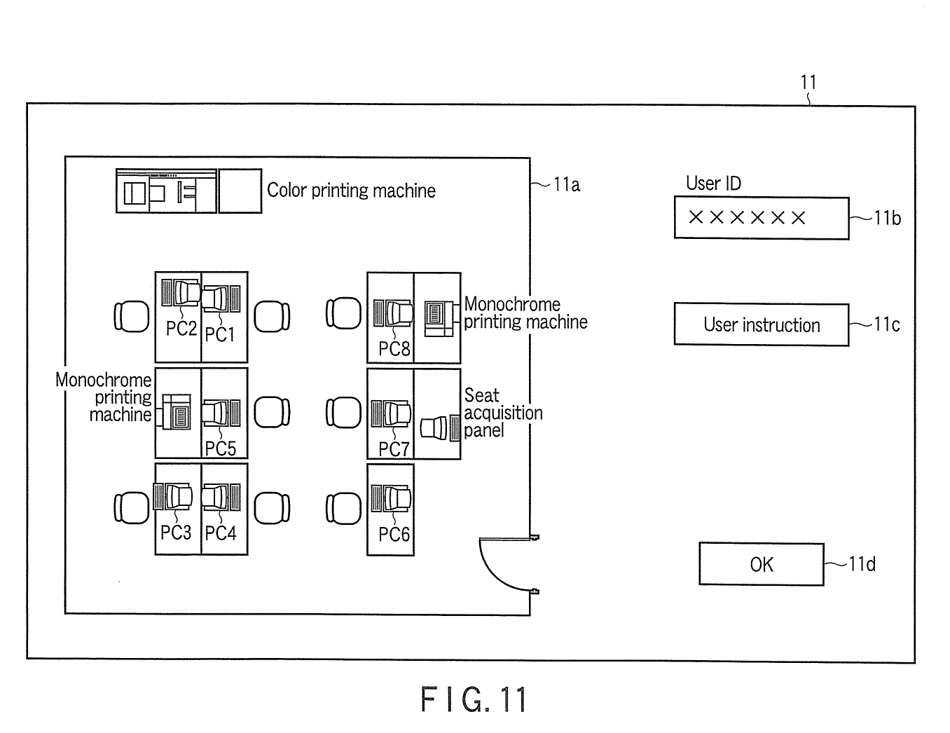

FIG. 11 is an exemplary diagram showing an input and output screen 11 of the seat acquisition panel 6 according to this embodiment.

In the input and output screen 11, a floor arrangement display area 11a, a user ID input field 11b, a user instruction button 11c, and an OK button 11d are provided. In the floor arrangement display area 11a, an arrangement of the seats and the printing apparatuses is displayed. In the user ID input field 11b, a user ID is input. The user instruction button 11c is set for the users to input their intent to reject the seat assignment instruction of the seat assignment system 2.

When the user comes to work and inputs a user ID into the user ID input field 11b of the input and output screen 11 and then presses the OK button 11d, the seat assignment system 2 specifies the user using the user ID and indicates a seat for the corresponding user that is determined by the processes described above. For example, when the seat assigned to the corresponding user is PC1, the seat assignment system 2 blinks an icon or changes the color thereof representing the PC1 displayed on the floor arrangement display area 11a of the input and output screen 11 so as to be highlighted. The user can recognize through the display that the seat PC1 is assigned.

### Second Embodiment

In the seat assignment method according to the first embodiment, the seats of all the users for the next day are determined in advance. In a seat assignment method according to a second embodiment, the seat of a user is determined when the user comes to work. Like elements the same as those of the first embodiment are denoted by like reference numerals, and detailed description thereof will be omitted.

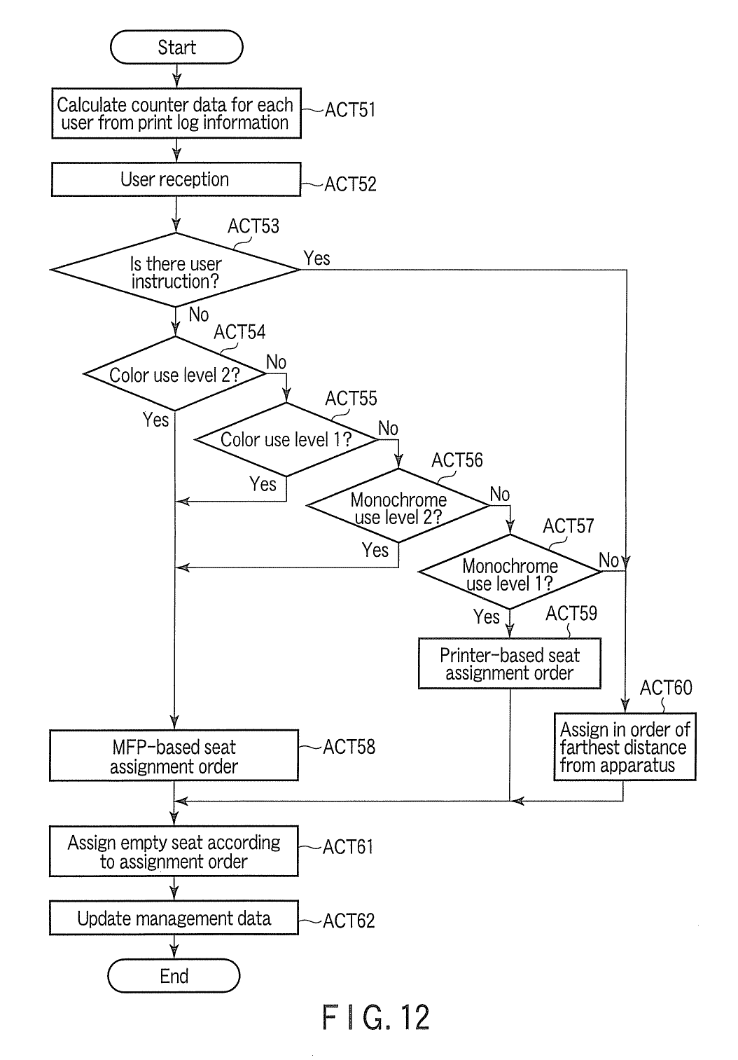

FIG. 12 is an exemplary flowchart showing a seat assignment process according to the second embodiment.

In ACT 51, the seat assignment system 2 acquires the number of color print sheets and the number of monochrome print sheets at a particular period for all users. The data is as shown in FIG. 6. The seat assignment system 2 calculates counter data for each of color printing and monochrome printing from the data.

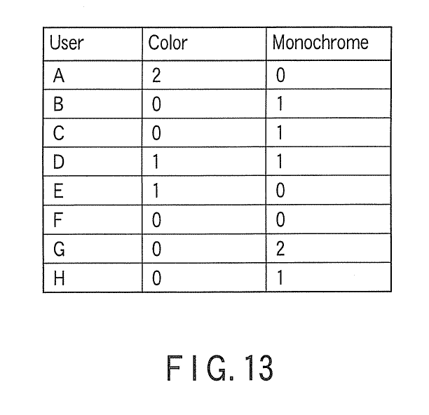

FIG. 13 is an exemplary diagram showing counter data for each user according to the second embodiment.

The counter data shown in FIG. 13 includes numbers from 0 to 2 determined depending on the number of sheets printed. The counter data of 2 represents mass printing in use. In this embodiment, when the number of sheets printed is equal to or more than 100, the counter data is set to 2. The counter data of 1 represents that printing in use may be determined. In this embodiment, when the number of sheets printed is 11 to 99, the counter data is set to 1. The counter data of 0 represents the number of sheets used for printing is small. In this embodiment, when the number of sheets printed is 0 to 10, the counter data is set to 0.

In ACT 52, the user requests seat acquisition from the seat acquisition panel 6 when they come to work. The seat assignment system 2 determines the seat of the corresponding user using the calculated counter data. When the user inputs their user ID into the user ID input field 11b of the input and output screen 11 and presses the OK button 11d, the seat assignment system 2 specifies the user using the user ID and performs the seat assignment process for the user.

In ACT 53, it is determined whether or not the user instruction button 11c is pressed. When the user instruction button 11c is pressed (Yes in ACT 53), in ACT 60, seats are assigned in the order of longest distance from the printing apparatus. Details of this operation will be described later.

When the user instruction button 11c is not pressed (No in ACT 53), according to the counter data shown in FIG. 12, a method of assigning seats is selected. That is, when the number of color print sheets is equal to or more than a predetermined number, or the number of monochrome print sheets is equal to or more than a predetermined number, in ACT 58, a method according to the MET-based seat assignment order is selected. When the number of monochrome print sheets is less than a predetermined number, in ACT 59, a method according to the printer-based seat assignment order is selected. In addition, the process of ACT 60 will be described later.

In the workflow from ACT 54 to ACT 57 of FIG. 12, when the counter data for color printing is 2 or 1, or when the counter data for monochrome printing is 2, in ACT 58, the method according to the MET-based seat assignment order is selected. When the counter data for monochrome printing is 1, in ACT 59, the method according to the printer-based seat assignment order is selected. In other cases, the method according to the process of ACT 60 is selected.

In ACT 61, according to the selected method, the seats are assigned to the corresponding users. Here, it means that the MFP-based seat assignment order and the printer-based seat assignment order respectively follow the seat assignment order for use of the MFP and the seat assignment order for use of the printer of FIG. 4. A detailed application method will be described later.

In ACT 62, the seat assignment system 2 reflects the assignment result here and updates management data for seat assignment.

Next, a specific first seat assignment example according to the seat assignment process of FIG. 12 is described.

The order in which the users come to work is assumed to be the order of the users A, B, C, D, E, F, G, and H. In addition, it is assumed that no users press the user instruction button 11c on the input and output screen 11.

With regard to the user A, in FIG. 12, the counter data for color printing is 2. Therefore, the seat is assigned according to the MFP-based assignment order. In FIG. 4, the PC1 is provided with the first rank in the seat assignment order for use of the MFP. Therefore, the PC1 is assigned to the user A. The seat assignment system 2 blinks the icon or changes the color thereof representing the PC1 displayed on the floor arrangement display area 11a of the input and output screen 11 so as to be highlighted. The user A can recognize through the display that the seat PC1 is assigned.

With regard to the user B, in FIG. 12, the counter data for color printing is 0, and the counter data for monochrome printing is 1. Therefore, the seat is assigned according to the printer-based assignment order. In FIG. 4, the PC8 is provided with the first rank in the seat assignment order for use of the printer. Therefore, the PC8 is assigned to the user B. The seat assignment system 2 blinks an icon or changes the color thereof representing the PC8 displayed on the floor arrangement display area 11a of the input and output screen 11 so as to be highlighted. The user B can recognize through the display that the seat PC8 is assigned.

Hereinafter, seat assignment for the users C to H will be simply described.

With regard to the user C, the counter data for color printing is 0, and the counter data for monochrome printing is 1. Therefore, the PC5 which is second in the seat assignment order for use of the printer is assigned. With regard to the user D, the counter data for color printing is 1, and the counter data for monochrome printing is 1. Therefore, the PC2 which is second in the seat assignment order for use of the MFP is assigned. With regard to the user E, the counter data for color printing is 1, and the counter data for monochrome printing is 0. Therefore, the PC5 which is third in the seat assignment order for use of the MFP should be assigned. However, since the PC5 is already assigned, the PC8 which is fourth in the seat assignment order for use of the MFP should be assigned. However, since the PC8 is already assigned, the PC7 which is fifth in the seat assignment order for use of the MFP is assigned.

With regard to the user F, the counter data for color printing is 0, and the counter data for monochrome printing is 0. Therefore, the PC6 which has the final eighth rank in the seat assignment order for use of the MFP is assigned. With regard to the user G, the counter data for color printing is 0, and the counter data for monochrome printing is 2. Therefore, the PC3 which is sixth in the seat assignment order for use of the MFP is assigned. With regard to the user H, the counter data for color printing is 0, and the counter data for monochrome printing is 1. Therefore, the PC3 which is third in the seat assignment order for use of the printer should be assigned. However, since the PC3 is already assigned, the PC2 which is fourth in the seat assignment order for use of the printer, and the PC7 which is fifth in the seat assignment order should be assigned. However, since the PC2 and PC7 are already assigned, the PC4 which is sixth in the seat assignment order for use of the printer is assigned.

Next, a specific second seat assignment example according to the seat assignment process of FIG. 12 is described.

The order in which the users come to work is assumed to be the order of the users A, G, F, C, B, E, D, and H. In addition, it is assumed that no users press the user instruction button 11c on the input and output screen 11.

With regard to the user A, the counter data for color printing is 2, and the counter data for monochrome printing is 0. Therefore, the PC1 which is first in the seat assignment order for use of the MFP is assigned. With regard to the user G, the counter data for color printing is 0, and the counter data for monochrome printing is 1. Therefore, the PC2 which is second in the seat assignment order for use of the MFP is assigned. With regard to the user F, the counter data for color printing is 0, and the counter data for monochrome printing is 0. Therefore, the PC6 which has the final eighth rank in the seat assignment order for use of the MFP is assigned. With regard to the user C, the counter data for color printing is 0, and the counter data for monochrome printing is 1. Therefore, the PC8 which is first in the seat assignment order for use of the printer is assigned.

With regard to the user B, the counter data for color printing is 0, and the counter data for monochrome printing is 1. Therefore, the PCS which is second in the seat assignment order for use of the printer is assigned. With regard to the user E, the counter data for color printing is 1, and the counter data for monochrome printing is 0. Therefore, the PC5 which is third in the seat assignment order for use of the MFP should be assigned. However, since the PCS is already assigned, the PC8 which is fourth in the seat assignment order for use of the MFP should be assigned. However, since the PC8 is already assigned, the PC7 which is fifth in the seat assignment order for use of the MFP is assigned.

With regard to the user D, the counter data for color printing is 1, and the counter data for monochrome printing is 1. Therefore, the PC3 which is sixth in the seat assignment order for use of the MFP is assigned. With regard to the user H, the counter data for color printing is 0, and the counter data for monochrome printing is 1. Therefore, the PC3 which is third in the seat assignment order for use of the printer should be assigned. However, since the PC3 is already assigned, the PC2 which is fourth in the seat assignment order for use of the printer, and the PC7 which is fifth in the seat assignment order should be assigned. However, since the PC2 and PC7 are already assigned, the PC4 which is sixth in the seat assignment order for use of the printer is assigned.

Next, a specific third seat assignment example according to the seat assignment process of FIG. 12 is described.

The order in which the users come to work is assumed to be the order of the users A, G, F, C, B, E, D, and H. Since the user G is expected to go on a business trip on the day, the user G is assumed to press the user instruction button 11c on the input and output screen 11. The other users do not press the user instruction button 11c on the input and output screen 11.

With regard to the user A, the counter data for color printing is 2, and the counter data for monochrome printing is 0. Therefore, the PC1 which is first in the seat assignment order for use of the MFP is assigned. With regard to the user G, a user designation is input. Therefore, the counter data for color printing is treated as 0, and the counter data for monochrome printing is treated as 0. Therefore, the PC6 which has the final eighth rank in the seat assignment order for use of the MFP is assigned. With regard to the user F, the counter data for color printing is 0, and the counter data for monochrome printing is 0. Therefore, the PC6 which has the final eighth rank in the seat assignment order for use of the MFP should be assigned. However, the PC8 is already assigned. Therefore, the PC4 which is seventh in the seat assignment order for use of the MFP is assigned.

With regard to the user C, the counter data for color printing is 0, and the counter data for monochrome printing is 1. Therefore, the PC8 which is first in the seat assignment order for use of the printer is assigned. With regard to the user B, the counter data for color printing is 0, and the counter data for monochrome printing is 1. Therefore, the PCS which is second in the seat assignment order for use of the printer is assigned. With regard to the user E, the counter data for color printing is 1, and the counter data for monochrome printing is 0. Therefore, the PC2 which is second in the seat assignment order for use of the MFP is assigned.

With regard to the user D, the counter data for color printing is 1, and the counter data for monochrome printing is 1. Therefore, the PC5 which is third in the seat assignment order for use of the MFP should be assigned. However, since the PC5 is already assigned, the PC8 which is fourth in the seat assignment order for use of the MFP should be assigned. However, since the PC8 is already assigned, the PC7 which is fifth in the seat assignment order for use of the MFP is assigned. With regard to the user H, the counter data for color printing is 0, and the counter data for monochrome printing is 1. Therefore, the PC3 which is third in the seat assignment order for use of the printer is assigned.

According to the embodiments described above, seat assignment that can enhance efficiency of the printing operations can be realized on the basis of the usage situations of the printing apparatuses for each user.

For example, users who need a large number of sheets printed may be positioned in the proximity of the printing apparatus. In addition, the usage situations for color printing and monochrome printing are separately managed, and the volume of printing jobs in use of each of the color printing and the monochrome printing may be set as a parameter to assign seats. Therefore, positioning those users who only perform monochrome printing in the proximity of the monochrome printing apparatus can be realized.

In addition, as particular periods at which the log information is collected as described above, the day or the previous day, a particular period in the past (a week, a month, a year, or the like), time bands at a particular period in the past such as in AM or in PM may be designated. Therefore, seats may be determined depending on the volume of print jobs based on the time, day of the week, and the like according to the mode of operation of the users.

In addition, the seats may be assigned in consideration of exceptional conditions such as business trips and being out. In the embodiments described above, the user inputs the exceptional condition on the day. However, the seats may be assigned by receiving information from an external work management system and considering the work schedules of the users.

In addition, in the embodiments described above, the printing management system and the seat assignment system are different apparatuses. However, the functions described above may be realized by a system combining the two systems.

In addition, in the embodiments described above, the 8 users and the 3 printing apparatuses are objects. However, the invention is not limited thereto, and it is apparent that more users and a large number of printing apparatus may also be objects. In this case, on the basis of various types of data included in the log information, the seats may be assigned minutely.

In addition, the functions described according to the above embodiments may be configured using hardware, or may be realized by reading programs in which each function is written to a computer using software. In addition, each function may be configured by appropriately selecting either of software and hardware.

Moreover, each function may be realized by reading programs stored on a recording medium (not shown) on a computer. Here, the recording medium in this embodiment may record programs, and any recording format may be employed as long as the recording medium can be read by the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system for assigning a plurality of seats to a plurality of users who use a plurality of printing apparatuses, comprising:
a memory configured to store seat information which applies rank order to the plurality of seats for each of the printing apparatuses;
an interface configured to acquire log information on print jobs from the printing apparatuses and store the acquired log information in the memory; and
a controller configured to aggregate the number of sheets printed by each of the printing apparatuses for each of the users on the basis of the log information, specify the printing apparatus for each of the users using the number of sheets printed by each of the printing apparatuses aggregated for each of the users and determine a seat assignment order for the users, and assign a seat which is not yet assigned and has the highest rank from among the seats rank ordered for the printing apparatus specified for the users in the determined order.

2. The system according to claim 1, wherein, in the seat information, the seats are rank ordered in the seat order of shortest travelling distance to the printing apparatus.

3. The system according to claim 2, wherein, when the seat assignment order is determined, the controller determines a priority rank order of each of the printing apparatuses on the basis of the number of sheets printed by each of the printing apparatuses aggregated for each of the users, specifies the printing apparatus having the highest priority rank from among the printing apparatuses for each of the users, and determines the seat assignment order for the users from the priority rank order of the specified printing apparatus.

4. The system according to claim 3,
wherein, in the aggregation, the number of sheets printed is aggregated for a predetermined period, and
the predetermined period includes any one of the day, the previous day, a particular period in the past, and a time band at a particular period in the past.

5. The system according to claim 2,
wherein the printing apparatus is a color printing apparatus having color printing and monochrome printing functions, or a monochrome printing apparatus having the monochrome printing function, and
the number of sheets printed is the number of color print sheets and the number of monochrome print sheets.

6. The system according to claim 5,
wherein, in the determination of the seat assignment order,
the controller determines the priority rank order as a descending order of the total value of the number of color print sheets and the number of monochrome print sheets aggregated for each of the color printing apparatus and the monochrome printing apparatus, on the basis of the number of color print sheets and the number of monochrome print sheets of each of the color printing apparatus and the monochrome printing apparatus aggregated for each of the users,
specifies the color printing apparatus or the monochrome printing apparatus which has the highest priority rank from among the color printing apparatus and the monochrome printing apparatus for each of the users, and
determines the seat assignment order for the users from the priority rank order of the specified color printing apparatus or the monochrome printing apparatus.

7. The system according to claim 6,
wherein, in the aggregation, the number of sheets printed is aggregated for a predetermined period, and
the predetermined period includes any one of the day, the previous day, a particular period in the past, and a time band at a particular period in the past.

8. The system according to claim 7, wherein the interface periodically requests the log information from the color printing apparatus and the monochrome printing apparatus.

9. A system for assigning a plurality of seats to a plurality of users who use a plurality of printing apparatuses, comprising:
a memory configured to store seat information which applies rank order to the plurality of seats for each of the printing apparatuses;
an interface configured to acquire log information on print jobs from the printing apparatuses and stores the acquired log information in the memory; and
a controller configured to aggregate the number of sheets printed by each of the printing apparatuses for the users on the basis of the log information when assignment of the seat is requested by the user, specify the printing apparatus applied to the user from the number of sheets printed by each of the printing apparatuses aggregated for the user, and assign a seat which is not yet assigned and has the highest rank from among the seats rank ordered for the specified printing apparatus to the user.

10. The system according to claim 9, wherein, in the seat information, the seats are rank ordered in the seat order of shortest travelling distance to the printing apparatus.

11. The system according to claim 10, wherein, in the assignment of the seats, when an exceptional designation is performed by the user at a request of seat assignment, the controller assigns the seat which is not yet assigned and has the lowest rank from among the seats rank ordered for the specified printing apparatus.

12. The system according to claim 11,
wherein, in the aggregation, the number of sheets printed is aggregated for a predetermined period, and
the predetermined period includes any one of the day, the previous day, a particular period in the past, and a time band at a particular period in the past.

13. The system according to claim 9,
wherein the printing apparatus is a color printing apparatus having color printing and monochrome printing functions, or a monochrome printing apparatus having the monochrome printing function, and
the number of sheets printed is the number of color print sheets and the number of monochrome print sheets.

14. The system according to claim 13, wherein, when an exceptional designation is performed by the user at a request of the seat assignment, the controller assigns the seat which is not yet assigned and has the lowest rank from among the seats rank ordered for the specified color printing apparatus or the monochrome printing apparatus.

15. A seat assignment method of assigning a plurality of seats to a plurality of users who use a plurality of printing apparatuses, comprising:
acquiring seat information which applies rank order to the plurality of seats for each of the printing apparatuses;
acquiring and storing log information on print jobs from the printing apparatuses;
aggregating the number of sheets printed by each of the printing apparatuses for each of the users on the basis of the log information;
specifying the printing apparatus for each user using the number of sheets printed by each of the printing apparatuses aggregated for each of the users and determining a seat assignment order for the users; and
assigning the seat which is not yet assigned and has the highest rank from among the seats rank ordered for the printing apparatus specified for the user in the determined order.

16. The method according to claim 15, wherein, in the seat information, the seats are rank ordered in the seat order of shortest travelling distance to the printing apparatus.

17. The method according to claim 16,
wherein the determining the seat assignment order comprises,
determining a priority rank order of each of the printing apparatuses on the basis of the number of sheets printed by each of the printing apparatuses aggregated for each of the users,
specifying the printing apparatus having the highest priority rank from among the printing apparatuses for each of the users, and
determining the seat assignment order for the users from the priority rank order of the specified printing apparatus.

18. The method according to claim 17,
wherein, in the aggregation, the number of sheets printed is aggregated for a predetermined period, and
the predetermined period includes any one of the day, the previous day, a particular period in the past, and a time band at a particular period in the past.

19. The method according to claim 16,
wherein the printing apparatus is a color printing apparatus having color printing and monochrome printing functions, or a monochrome printing apparatus having the monochrome printing function, and
the number of sheets printed is the number of color print sheets and the number of monochrome print sheets.

20. The method according to claim 19,
wherein, the determining the seat assignment order comprises,
determining the priority rank order as a descending order of the total value of the number of color print sheets and the number of monochrome print sheets aggregated for each of the color printing apparatus and the monochrome printing apparatus, on the basis of the number of color print sheets and the number of monochrome print sheets of each of the color printing apparatus and the monochrome printing apparatus aggregated for each of the users,
specifying the color printing apparatus or the monochrome printing apparatus which has the highest priority rank from among the color printing apparatus and the monochrome printing apparatus for each of the users, and
determining the seat assignment order for the users from the priority rank order of the specified color printing apparatus or the monochrome printing apparatus.
